(19) United States
(12) Patent Application Publication
(10) Pub. No.: US 2017/0169388 A1
(43) Pub. Date: Jun. 15, 2017

(54) ADMINISTRATION SYSTEM FOR GIFT DELIVERY TO PERSONS HAVING UNKNOWN DELIVERY ADDRESSES

(71) Applicants: Raj Lwin, Deerfield Beach, FL (US); Graig Theobald, Deerfield Beach, FL (US)

(72) Inventors: Raj Lwin, Deerfield Beach, FL (US); Graig Theobald, Deerfield Beach, FL (US)

(21) Appl. No.: 14/969,929

(22) Filed: Dec. 15, 2015

(51) Int. Cl. G06Q 10/08

(52) U.S. Cl. CPC G06Q 10/0836

(57) ABSTRACT

An administrative system for managing order transactions to facilitate selection and delivery of items and services to persons of unknown legal identity also having an originally unknown delivery address. The system include a server configured to qualify a prospective registrant and to acquire a cell phone number or screen name of a prospective recipient; to forward to either the cell phone number, an email or screen name of a prospective recipient, a congratulatory message, including a notification to a person in possession of the acquired cell phone number or screen name; to invite the prospective recipient to enter server provided identification codes into an internet-connected site and to provide a delivery address to the server; and to effect a delivery of a selected item, optionally with a message from the originator, to the delivery address furnished by the recipient.

### BACKGROUND OF THE INVENTION

1. Area of Invention

This invention relates to an administration system for gift or other deliveries and is particularly applicable to a gift or other delivery process that is initiated by a transaction established over a communications network, such as the internet, and fulfilled by delivery of an order to a third party where the address of the recipient is initially unknown.

2. Prior Art

Numerous systems of online gift delivery exist in the prior art, many associated with social networks. Examples thereof include U.S. Pat. No. 7,006,989 (2006) to Bezos, U.S. Pat. No. 7,606,738 (2009) to Storch, and U.S. Patent Application Publications US2013/0173424 (2013) to Kwon and US2014/0279281 (2014) to Tolcher. A problem however with all online gift selection and delivery systems is the requirement for a physical address to effect delivery of the gift selected, be it by the gift giver or the prospective gift recipient. Situations in which the physical address of a recipient may be unknown occur in many social situations including, for example, those in which the prospective gift giver and gift recipient have met in a casual social context such as a social venue in which the only information provided by the prospective gift recipient to the prospective gift provider is that of a telephone number. Alternatively, individuals may meet in any of numerous online communities in which a pseudonym, screen name or the like is employed in lieu of one's legal name. Such screen names are however typically associated with email or web addresses such that anonymous parties are able to communicate with each other, when desired. Nonetheless, a result of such scenarios in which people may meet anonymously or, in the case of a social venue such as a night club, semi-anonymously, is that one or the other party may wish to attempt to further the relationship by sending a gift, or an option to receive a gift, from a fulfillment site to the other party.

Accordingly, embodiments of the invention enable a gift-giver to send a gift to a gift recipient even when the gift recipient's specific shipping or delivery address is unknown to the gift-giver.

Apart from the above, there exist numerous conventional relationships in which the gift giver may seek a reliable means of sending a gift to another party or providing to the prospective recipient a selection of various categories of gifts having up to a defined or maximum dollar value. Further, many individuals may wish to assure that gifts will always be given, or at least offered, to family members, valued employees, or the like at given times or dates. As such, the present system affords a manner by which such gifts may be repetitively delivered or made available for selection by the recipient at certain times throughout the year.

The present system addresses various online gift and delivery issues inclusive of those where, as a starting point, no physical or contact address whatever is available for the prospective gift recipient. As such, the present invention addresses this long felt need in the art.

### SUMMARY OF THE INVENTION

An administrative system for managing order to facilitate selection and delivery of items, services and, optionally, messages to persons of known or unknown legal identity also having an originally unknown delivery address. The administrative system includes a server configured to acquire a cell phone number, email or screen name of a prospective gift recipient; to forward to either said cell phone number, email, or an online community related screen name of a prospective recipient, a notification including a product or service advisory to the person in possession of the acquired cell phone, email or screen name; to invite the prospective recipient to enter server provided identification codes into an internet-connected site and to provide a delivery address to the server; and to effect a delivery of a selected item or service, together with an optional message from the item originator, to the delivery address furnished by the prospective recipient.

It is accordingly an object of the invention to provide a system for selection and delivery of gifts, other items and services with optionally associated messages to a recipient having a delivery address unknown to the item originator.

It is a further object to facilitate efficient and timely ordering of items by a member/user of items ordered at a convenient time for the member to reflect upon special recipients, the occasion and an appropriate gift therefore.

It is another object to provide a system that alleviates the concern of “forgetting” a special occasion thereof, including occasions that occur repetitively from year-to-year.

It is another object to provide a site offering “one-stop-shopping” in which many different items are available for different types of recipients and occasions.

It is another object to facilitate gift giving and receipt between parties that have met in an anonymous venue.

The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 is a flow diagrammatic view of a portion of the present system by which an applicant is qualified and by which searches for gifts and other items or services is conducted.

FIG. 2 is a flow diagrammatic view further to that of FIG. 1 and connected thereto at nodes A and B thereof, in which is shown the process of obtaining a physical address of a gift or item recipient whose delivery address is initially unknown to the system user.

FIG. 3 is a view, further to FIGS. 1 and 2, in which a text message is sent to a prospective product recipient.

FIG. 4 is a screen shot illustrating a notification of a prospective recipient in which the recipient is invited to enter redemption information by which a product may be selected or delivered.

FIG. 5 is a screen shot further to that of FIG. 4 in which a prospective recipient is invited to enter information necessary to effect selection and delivery of one's gift.

FIG. 6 is a screen shot illustrating the use and options of a system user in a cell phone application of the system.

FIG. 7 is a screen shot showing the appearance of the system when a new member wishes to register therefore.

FIG. 8 is a screen shot showing the “search gift” function of flowchart of FIG. 1.

FIG. 9 is a view, further to that of FIG. 8, in which the system member may enter the type of product he wishes to send and may select the credit card which he wishes to employ.

FIG. 10 is a view, further to that of FIG. 9, showing a member's summary of purchases during a transaction.

FIG. 11 is a view, further that of FIG. 6, showing the methods by which a member's order may be initiated and where the recipient's delivery information, if known, may be entered, as may be a personalized message, this as is also shown in FIG. 2.

FIG. 12 is a screen shot, further to that of FIG. 4, indicating that the selected item has been shipped to the recipient.

FIG. 13 is a list of system rules which are provided to each system member.

FIG. 14 is a flow diagram related to a bulk redemption and distribution application of the present system.

### DETAILED DESCRIPTION OF THE INVENTION

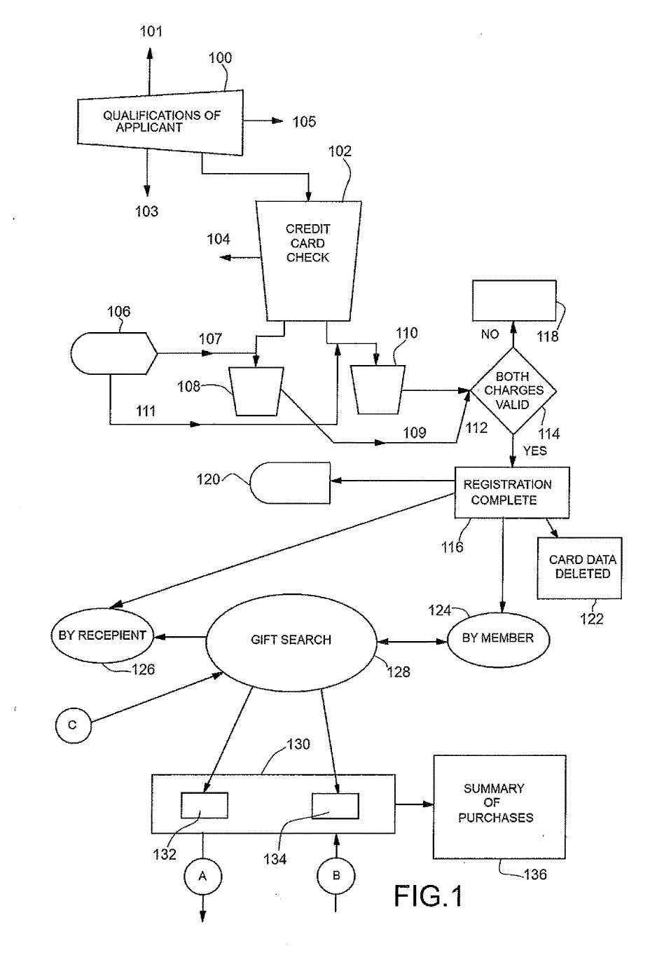

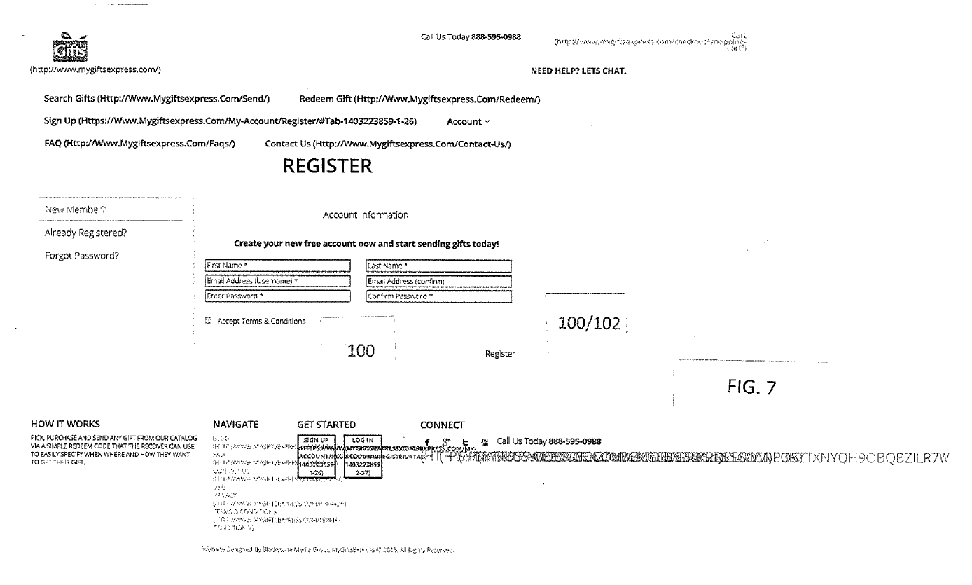

Viewing the invention, firstly, in terms of its functions and the relationships therebetween, indicated in FIG. 1 is the first step of the flow chart thereof, namely, step 100, that being the step of qualification of an applicant, i.e., a prospective gift or service giver or first party wishing to use the present system. Therein, as may be noted, a system applicant must first provide a name 101, an email address 103 and a password 105 for his prospective account. See also FIG. 7. Additionally, as noted at step 102, a new user must typically provide a credit or debit card, the validity of which is checked as a part of the qualification process unless the new applicant is deemed to be a low risk guest 104 of the system. This would typically be the case where one has previously qualified as a member and/or has but has indicated another party as his guest who then becomes a low risk guest with freedom to use the system up to a predetermined credit limit, or an already approved member wishing to leave sufficient credit card information with the system for further use. In such event, the historic credit card data of the member is retained, as indicated at step 120.

In a preferred embodiment, a credit/debit card validity check 102 begins by the display of test amounts 106 shown upon a graphical user interface (GUI) of the system. With this information line 107, a first test charge 108 is applied to the applicant's credit or debit card. For example, a test charge of 17 cents may be applied. At that point, the validity thereof is determined, as is indicated by line 109 of FIG. 1. If the first test charge is accepted, the system then acquires a second test charge 111 from GUI 106 and the amount thereof, for example, 23 cents, is applied as a second test charge 110. The result thereof is also recorded at validation decision engine 114. That is, if both test charges are approved by the applicant's credit card company or bank, the system proceeds to step 116 thereby finalizing the registration process of the applicant. However, if both charges are not valid, the applicant is asked to present a different credit/debit card as is indicted at block 118. Upon approval of an applicant, his membership information, other than credit card data, is retained, as is shown by online storage symbol 120. The deletion of applicant's credit card data, for charges other than the present one, is indicated at step 122, where the applicant does not request permanent membership. If permanent membership is requested, credit card data is stored at step 120. As is indicated at the middle of FIG. 1, the registrant's now authorized credit information may be employed either by a member/registrant or by a recipient (second party) authorized by the member/registrant, this as is more fully described below. A prospective gift may be searched or selected within database 130, this by either value 132, by category 134, or by both.

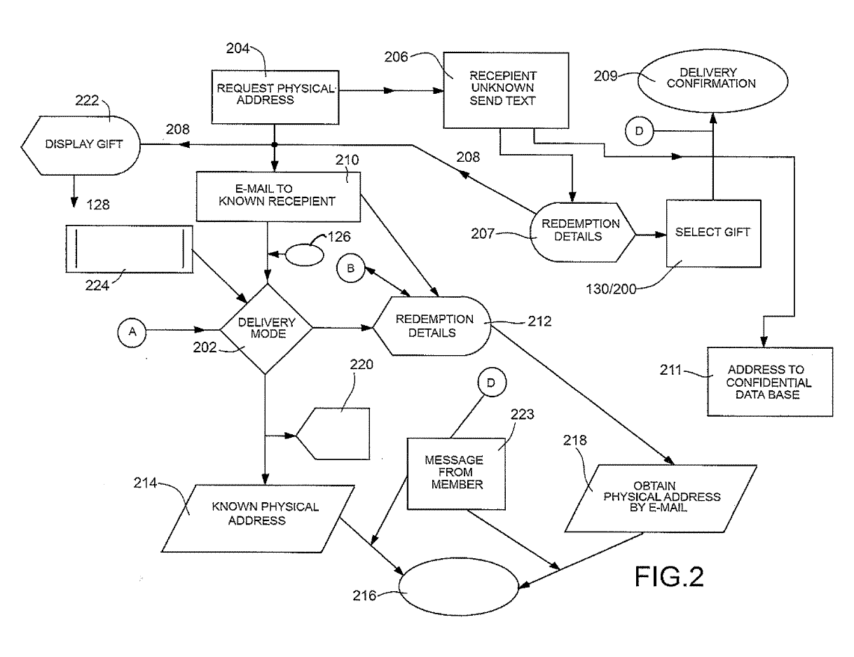

As may be noted in FIG. 2, the database of available gifts or items may not be the same for all members or recipients. More particularly, a party that can only be contacted by text or screen name, and/or that the gift giver has encountered in a casual venue, may be confined to particular gift database 200/222 as opposed to the general database 130 as above described with respect to FIG. 1.

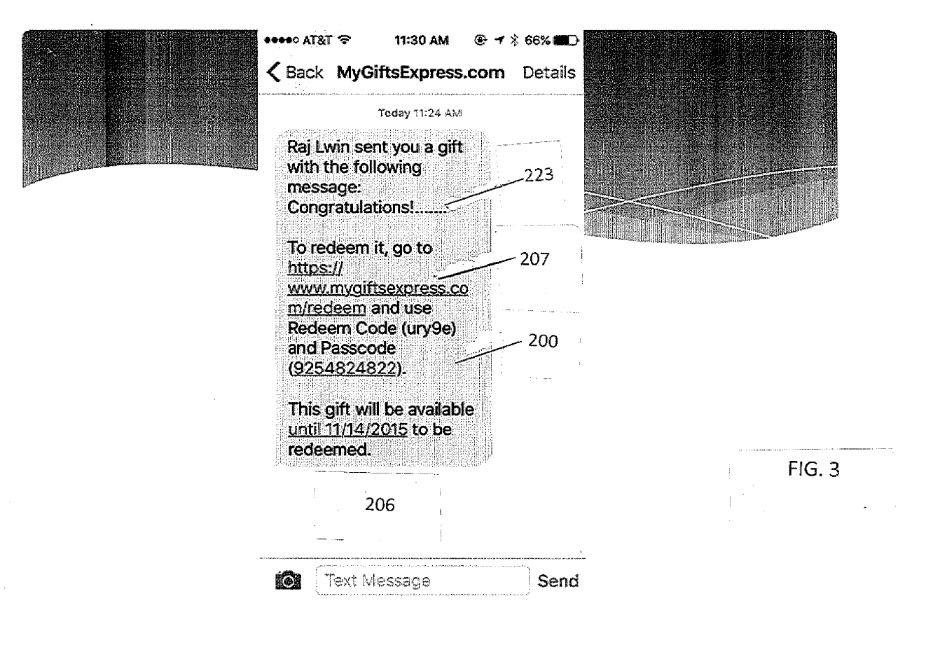

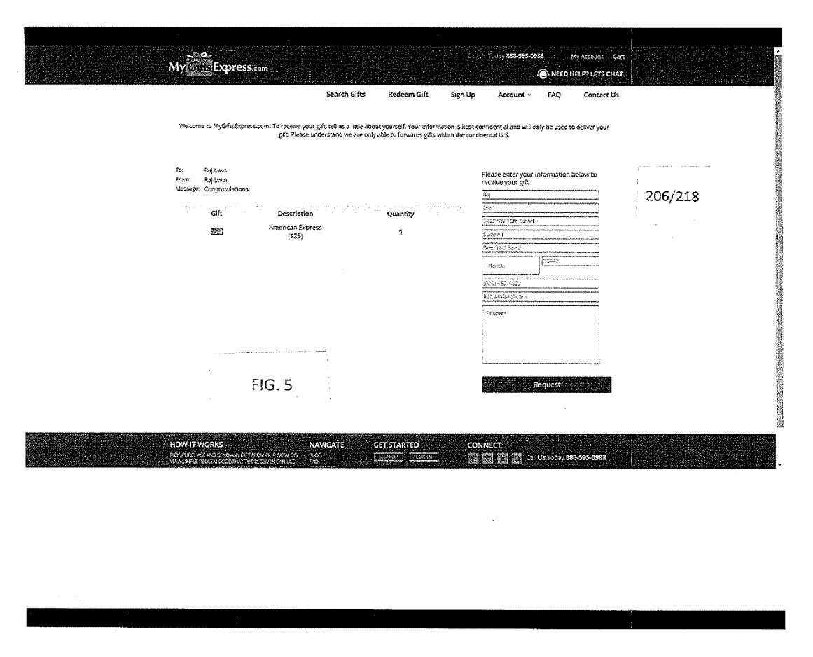

Various modes of delivery may be effected in the present system, this as is generally indicated at delivery modality point 202 of FIG. 2. In general, the delivery process begins by a determination of whether a gift recipient is known or unknown and whether his or her delivery address is known or unknown. As such, at step 204, the system will generate a text for the purpose of congratulating the recipient and soliciting a physical delivery address if the physical address of the recipient is unknown. That is, a text 206, shown more fully in FIGS. 3-5, is sent to the prospective recipient. Therefrom, if the recipient wishes to redeem his or her item, one proceeds to step 208 which requires that the recipient log onto the website as shown in the text of FIG. 5, using the designated redemption or verification code and pass code, these comprising redemption details shown at step 200/207 of FIG. 3. These details include limitations of value and/or category that the prospective gift giver may have provided upon initiation of the gift providing process. Clearly, such redemption details 208 would differ from redemption details 212 that would be applicable where the identity of the recipient is known which, typically, would be the case where the member is also in possession of the physical address of the gift recipient, as is shown at step 210 in FIG. 2.

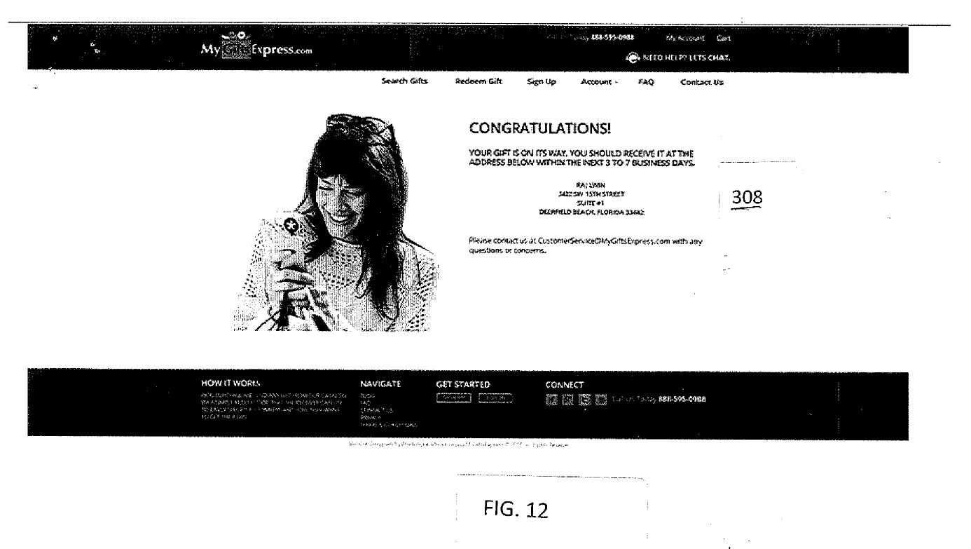

As may be seen at step 212 of redemption details of FIG. 2, one must connect to database 130 in FIG. 1 as is shown by node B in both figures. Similarly, in a conventional gift scenario, node A in FIG. 1 would connect to delivery modality point 202 of FIG. 2. Therefrom, following gift selection of node A, the delivery would occur to a known physical address of a known recipient, this as is shown at step 214 (see FIGS. 5 and 12) and thereafter delivery confirmation 216 would occur after message 223 from the member has, if desired, been integrated into the delivery process.

Where a physical address for the recipient is provided by the recipient, as opposed to the gift giver, such address is provided by email to the present system as is noted at step 218 and from there to delivery 216.

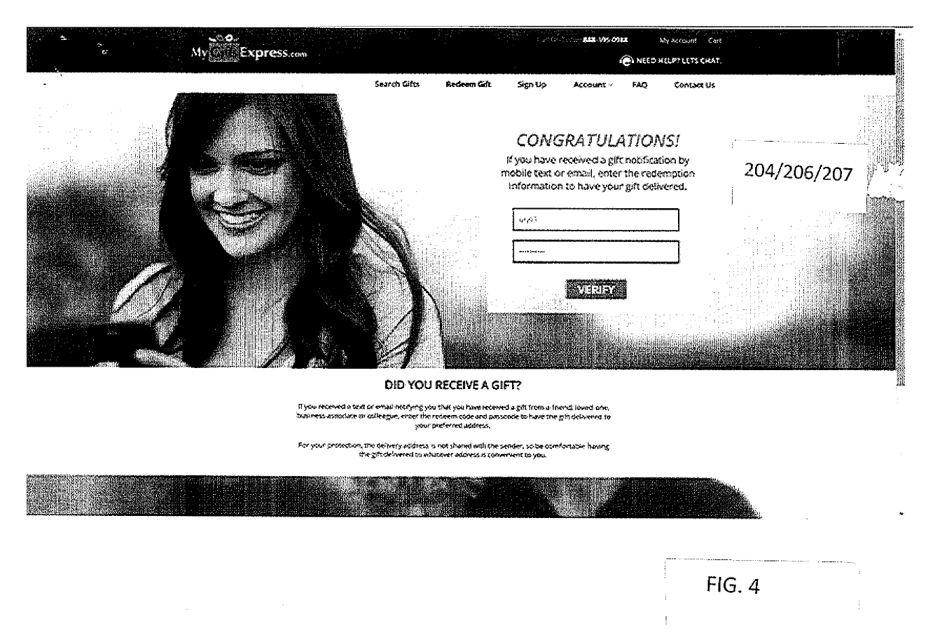

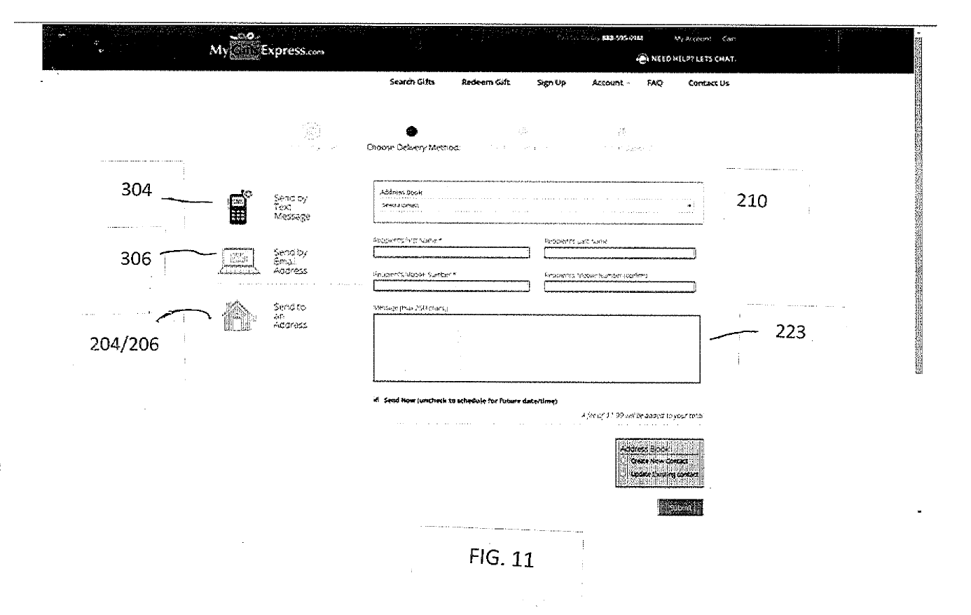

Further to the above, as may be noted at the upper right corner of FIG. 2, in which the recipient is unknown by a means other than a cellular phone number, email, or screen name, the ability of such a recipient to access the gift search and select engines 128 and 130 respectively are limited to the information displayed in the text of FIGS. 3 and 4. That is, there is no need for such a recipient to engage in the formal registration process above described. As such, the recipient will access the system through oval 126 of FIG. 1 or FIG. 2. However, to access the gifts for which such a recipient may qualify, he or she must input the redemption details (redemption code and pass word 217) from verification details step 208. Such verification details will lead the anonymous recipient to the select gift area 126/200 of the general gift search and select sites 128/130 of the system, this assuming that the unknown recipient has, responsive to step 206, provided a physical address to which the selected gift can be delivered. If such a physical address is provided, together with a recipient name, whether real or fictitious, an actual delivery 209 together an optional message 223 and a confirmation of the selected and delivered gift will occur. (See node D and FIG. 11.

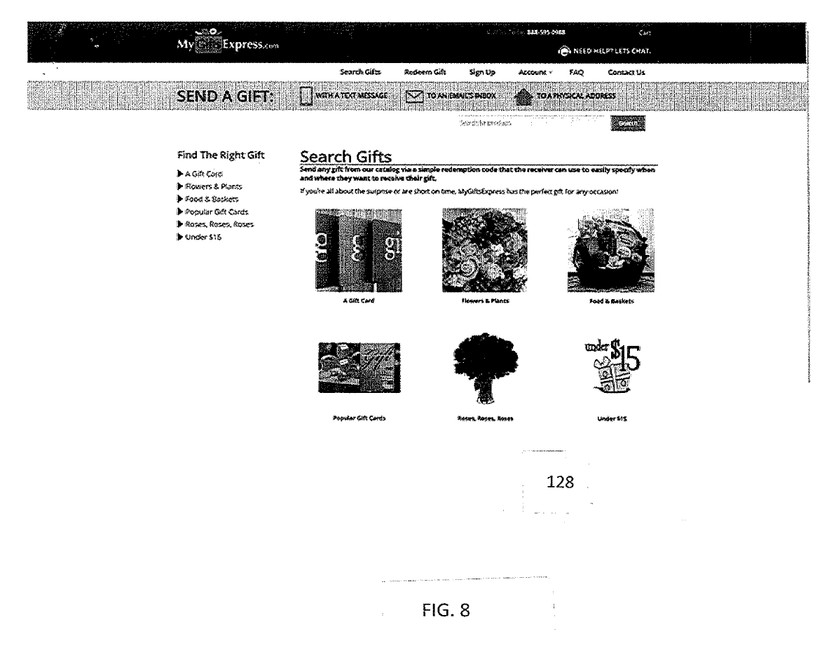

As above noted, unknown recipients may be contacted not simply through a cell phone number but, as well, through a social network screen name in which the actual name and other details of the prospective recipient are unknown. As such, the unknown recipient is encompassed within step 206. That is, whether the prospective recipient is unknown because the gift sender is unaware of a physical address of the recipient or is only aware of the individual through a cell phone number or a social media venue, gift selection 200 occurs after step 206, entry of redemption details 207, and display of gifts 222, following instructions on line 208 as is shown in FIGS. 2 and 8.

At step 211 of FIG. 2 is shown a significant function 211 of the instant system, namely, retention in confidence of the delivery address information of an originally unknown recipient at step 206.

If there is no hesitancy on the part of the prospective recipient to receive his or her gift, a simple request for a physical address is generated by the system at step 204, this typically occurring by email, but can also occur by text if the gift originating member prefers that email not be employed. See FIGS. 4-6,

After the prospective recipient has, either by email or text, received a congratulatory or other message of the type shown in FIGS. 3 to 5, he or she proceeds to oval 126 shown in FIG. 1, and then searches for a gift, in accordance with both value and category fields 132/134, within database 130, as is described above. The result of the gift selection process is indicated at node A in FIGS. 1 and 2. Therefrom, the gift recipient may review his or her cart as is shown at step 220. In the event that a prospective gift recipient wishes to review the gift database prior to providing his or her address, this may be effected at display step 222 shown at the upper left of FIG. 2. Thereupon, upon determination that one or more gifts may be of interest, the recipient may provide a delivery address at step 210. See also FIG. 8.

In deliveries, the gift may be sent with an accompanying message, in any language desired, as is indicated at step 223 of FIGS. 2 to 4, but this is not mandatory. Oval 216 indicates the general confirmation of delivery for all known recipients having a then known delivery address, whereas oval 209 represents deliver confirmation for unknown recipients which provide a physical address to the system.

As above noted, a system user, such as a corporation, may wish to periodically provide gifts to selected employees or, in a non-business context, one may wish to periodically provide or make available gifts to friends, relatives or the like. These constitute event-driven orders 224 in which a gift notification is sent on a pre-determined periodic basis to such select employees, friends or relative. Such prospective gift recipients then would begin their gift search at oval 126 shown in FIGS. 1 and 2.

In respect to implementation of the above system, there is shown herewith as FIG. 5, the initial registration process 100. This, as above described with respect to step 102, 106, 108, 110 and 114, entails a check of the applicant-member's credit or debit card. Thereafter, the member is free to employ the services of the present system either on his behalf or that of a third party such as a relative or company with which he is associated.

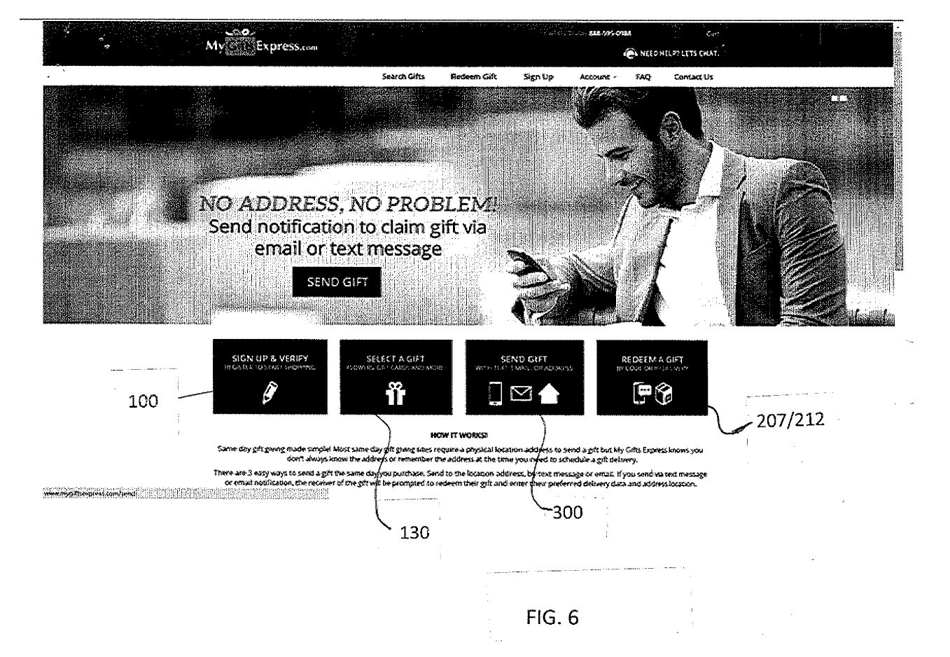

Shown in FIG. 6 is a screen shot indicating that a customer of the present system may readily advise a prospective gift recipient and is able to communicate the existence of the gift to an individual that he does not have an address for, this in the manner described above. If an address is then obtained, such a member may send a pre-selected gift 300 to his friend or associate, or the selection option may be provided to the prospective recipient of redeeming a gift of his or her choice, this shown as block 207 or 212 of FIGS. 2 and 5. In other words, the functions of the present system may be readily accessed and employed through a cell phone application, although one may also do so with a personal computer.

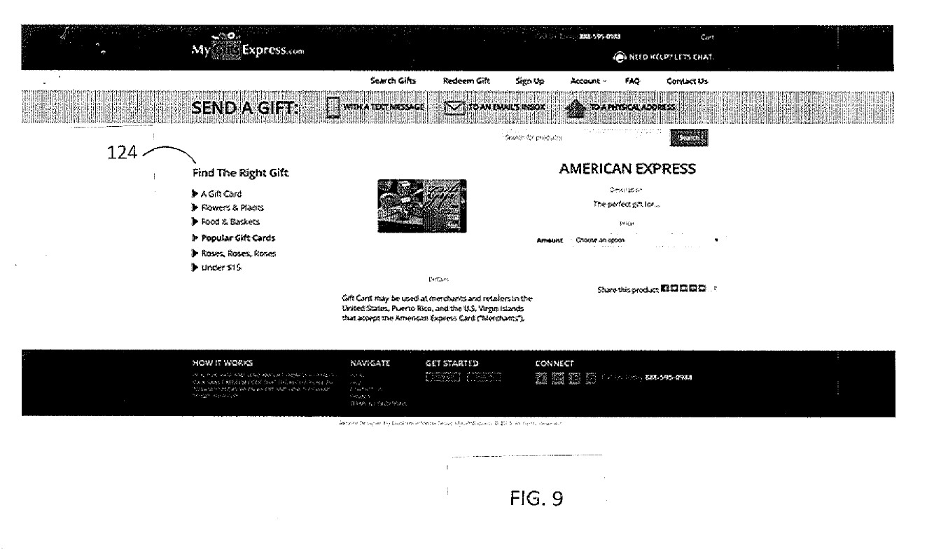

Shown in FIGS. 8-9 are screen shots of gift search function 128 which, therein, shows the availability of gifts within designated price ranges as well as gift cards. This assists the gift provider or recipient in identifying a particular gift card or gift that may of interest to him or her. In other words, FIGS. 8-9 represent the gift search engine 128. See also FIG. 1.

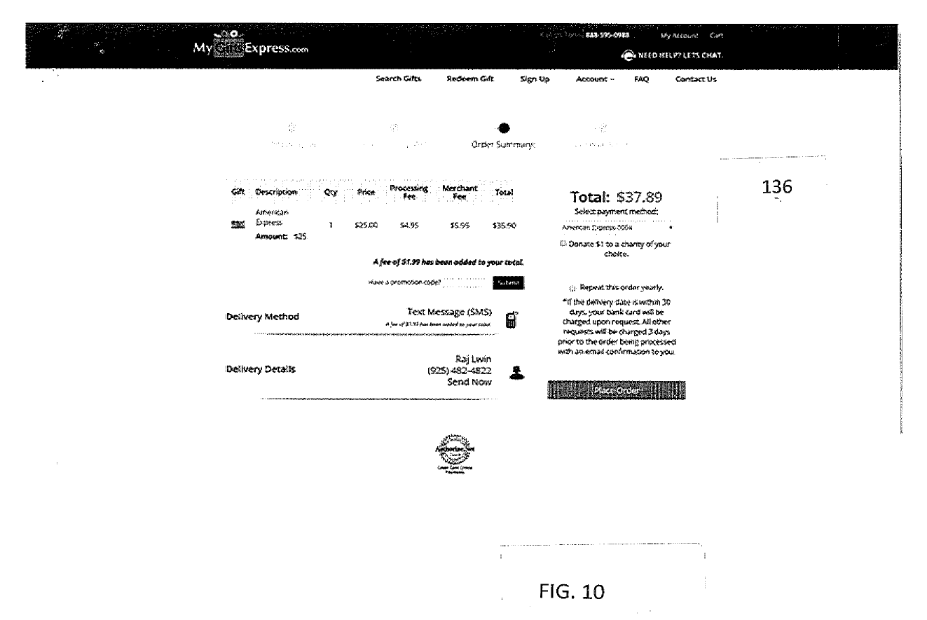

Shown in FIG. 10 is a summary of purchases 136 (see also FIG. 1) as the same would appear to a system user. In the event that there are particular delivery details or other information, this may be provided in the manner shown in the screen shot of FIG. 11, using text 304 or email 306.

After a particular gift has been dispatched, an informational message 308 of the type shown in FIG. 11 is provided to the recipient via email 306. However, in the event that the email of a gift recipient is not available, a text version 304 of the notification of FIG. 11 is provided.

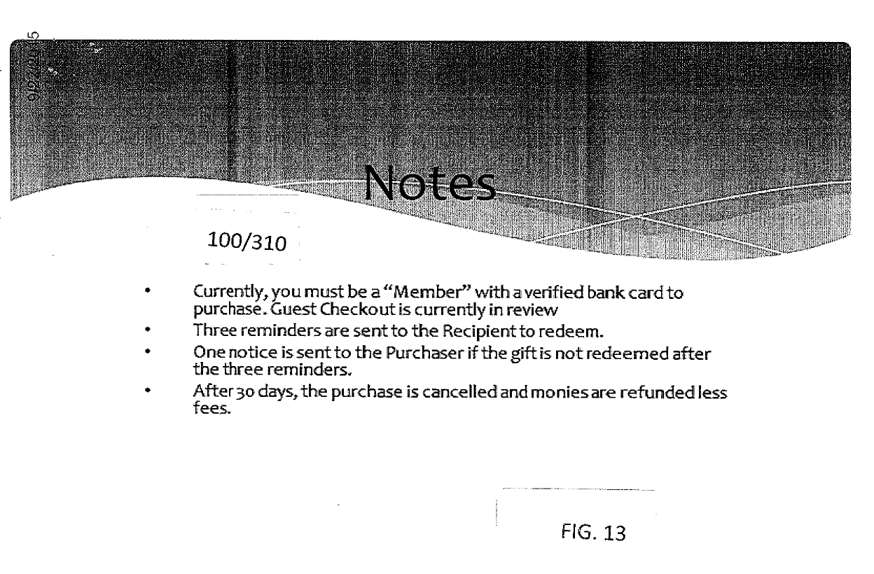

If a gift recipient fails to redeem a gift, several notices 310 are provided, these of the nature shown in FIG. 13, at which other system rules are also provided.

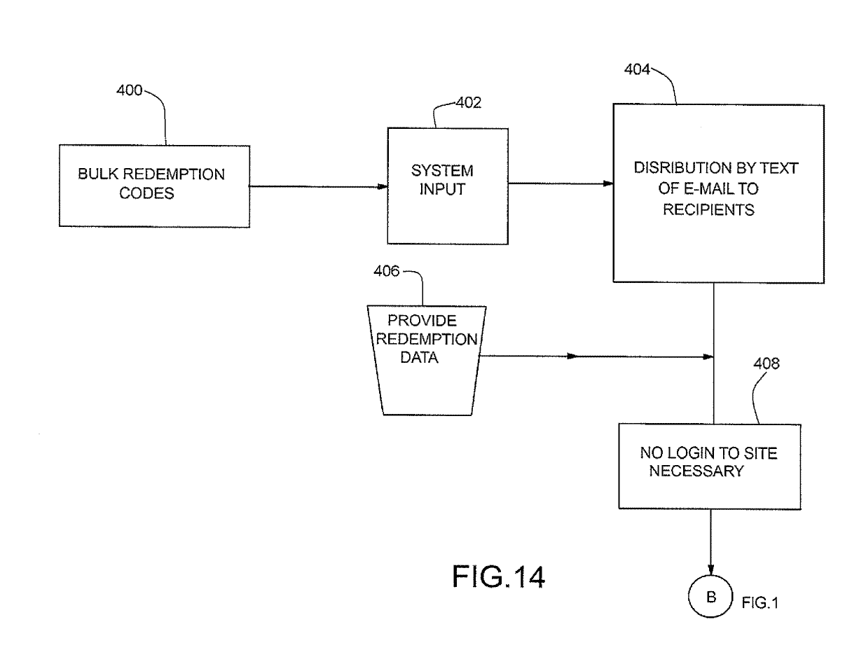

The system is also well adapted to so-called bulk redemptions which are redemptions of gifts which occur through the use of digital codes having embedded therein the gift to which it relates, this as is more fully shown in FIG. 14. By this method, particular redemption codes, or any number thereof, may be simply printed and then delivered either by postcard, email, or text to a cell phone. Such bulk redemptions may be bundled such that hundreds if not thousands of employees of a given company or organization may be provided with a gift on a particular occasion or tiers of gifts dependent upon the rank, seniority or the like of particular employees or associates.

In FIG. 14, the bulk redemption codes, tied to particular gifts are shown at step 400. Therefrom, the system is programmed to recognize these codes and the gifts to which they correspond, this indicated at step 402. Thereafter, distribution 404 of the codes to the intended recipients will occur. The recipients are then urged to provide their particular redemption code data as is indicated at step 406 by using their personal email, this indicated at step 408. Thereby, through node C, the recipient may proceed directly to gift search 128 unless the electronic code of the bulk redemption has been pre-programmed to a specific gift. However, more commonly, such redemption codes will be programmed to particular value limits 132 as discussed with respect to FIG. 1. Therein, one may select any gift within the value range programmed into the bulk redemption code 400.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

We claim:

1. An administrative system to facilitate selection and delivery of products, services, or other items to persons of unknown legal identity also having an originally known or unknown delivery address, the administrative system comprising:
a server configured:
(a) to communicate with a cell phone number, email, or screen name of a prospective recipient;
(b) to forward a notification to either said cell phone number, email or screen name of the recipient; and
(c) to invite the prospective recipient to enter provided identification codes into an internet-connected site and to provide a delivery address to the server to effect a delivery of a selected product or service.

2. The system as recited in claim 1, in which an identity, including the legal identity, of said recipient is also unknown.

3. The system as recited in claim 1, in which said identification codes are identified.

4. The system as recited in claim 1, said server configured to:
acquire or suggest a personalized message from a user to the recipient and delivering said message with the selected item or service upon delivery thereof.

5. The system as recited in claim 1, said server configured to maintain in a confidential database delivery addresses of recipients.

6. A fulfillment system enabling a qualified first party to purchase an item or service for a second party known only to the first party by a cell phone number, email account or online community screen name, the system comprising:
(a) a module programmed to maintain in confidence a database of delivery addresses corresponding to historic recipients having particular cell phone numbers, email addresses and screen names;
(b) a website accessible by said first party and by said second party to the extent of limit parameters provided by a system administrator;
(c) a notification module programmed to:
(i) provide a notification to said second party;
(ii) urging said party to redeem one's item by accessing certain web pages of the fulfillment system and thereafter employing a parameter pass code included within said notification; and
(iii) provide a delivery address to be stored in said module (a).

7. The system as recited in claim 6, further comprising:
a module for substantially providing of parameters regarding a multiplicity of second parties with whom said first party maintains a relationship of particular trust or esteem.

8. The system as recited in claim 6, said notification module (c) further programmed to acquire or generate a personalized message from the first party and delivering the same with the selected item of the second party upon delivery thereof.

9. The system as recited in claim 6, further comprising:
a database of qualified first parties and credit limits associated with said first party.

10. The system as recited in claim 8, further comprising:
a module for displaying prospective gifts according to a category or occasion associated with a specified relationship between said first party and said second party.

11. An administrative system for managing order to facilitate selection and delivery of products, services, or other items to persons of known or unknown legal identity also having an originally unknown delivery address, the administrative system comprising:
a server configured:
(a) to qualify a prospective system registrant;
(b) to communicate with a cell phone number, email or screen name of a prospective gift recipient;
(c) to forward a notification to either said cell phone number, email or screen name of the recipient; and
(d) to invite the prospective recipient to enter provided identification codes into an internet-connected site and to provide a delivery address to the server to effect a delivery of a selected item.

12. The system as recited in claim 11, said server configured to:
acquire or suggest a personalized message from the registered user to the recipient and delivering said message with the selected item or service upon delivery thereof.

13. The system as recited in claim 11, said server configured to maintain in a confidential database delivery addresses of recipients.

14. The system as recited in claim 11, in which a verification of credit details of said prospective registrant is conducted.

15. The system as recited in claim 14, in which credit limits to said registration are provided.
